(19) United States
(12) Patent Application Publication
(10) Pub. No.: US 2014/0365493 A1
(43) Pub. Date: Dec. 11, 2014

(54) DATA PROCESSING METHOD AND DEVICE

(71) Applicant: Tencent Technology (Shenzhen) Company Limited, Shenzhen City (CN)

(72) Inventors: Yi YANG, Shenzhen City (CN); Yongqiang ZOU, Shenzhen City (CN); Ke LU, Shenzhen City (CN); Zheng CHEN, Shenzhen City (CN); Haijun WU, Shenzhen City (CN); Tao YU, Shenzhen City (CN); Luxin LI, Shenzhen City (CN); Jiaxu WU, Shenzhen City (CN); Jingbing CUI, Shenzhen City (CN); Diaoqin XIN, Shenzhen City (CN); Zan ZOU, Shenzhen City (CN)

(21) Appl. No.: 14/296,099

(22) Filed: Jun. 4, 2014

Related U.S. Application Data
(63) Continuation of application No. PCT/CN2013/089576, filed on Dec. 16, 2013.

(30) Foreign Application Priority Data
Jun. 5, 2013 (CN) 201310221032.X

(51) Int. Cl. G06F 17/30

(52) U.S. Cl. CPC G06F 17/30705
USPC 707/738

(57) ABSTRACT

A data processing method is provided, which includes: performing a fingerprint calculation for each data element of a set of data elements to obtain fingerprint information of the data elements; grouping the data elements into data groups in accordance with the fingerprint information, including by grouping data elements with the same fingerprint information into a same data group; and selecting a particular data element from each of the data groups for modeling calculation. A corresponding device is described. With the technical solutions according to the present method, data processing amount for modeling calculation may be reduced, which may thereby reduce data processing time and improve the data processing efficiency.

### RELATED APPLICATIONS

This application is a continuation application of International Application No. PCT/CN2013/089576, titled “Data processing method and device”, filed on Dec. 16, 2013, which claims priority to Chinese patent application No. 201310221032.X titled “Data processing method and device” and filed with the State Intellectual Property Office on Jun. 5, 2013, each of which are entirely incorporated herein by reference.

### FIELD

The present disclosure relates to the technical field of data processing, and in particular to a data processing method and device.

### BACKGROUND

With the development of the Internet, the amount of information has increased in an explosive way and the volume of data to be processed has increased quickly. The existing processing methods are mainly divided into two types.

One type of method is to analyze all data and establish an empirical model according to the results of the analysis of all the data, and the other type of method is to cluster data firstly and then establish an empirical model according to the clustered data.

### SUMMARY

A data processing method according to an embodiment of the present disclosure can reduce data processing load for a modeling calculation, and thereby the time for data processing may be reduced and the efficiency for data processing may be improved. A corresponding device is also provided in an embodiment of the present disclosure.

In a first aspect of the present disclosure, a data processing method is provided, which includes: performing a fingerprint calculation on each data element of a set of data elements to obtain fingerprint information of the data elements; grouping the data elements into data groups in accordance with the fingerprint information by grouping data elements with the same fingerprint information into a same data group; and selecting a particular data element from each of the data groups for modeling calculation in accordance with a preset strategy.

Optionally, selecting the particular data element from each of the data groups may include, for a first data group among the data groups: calculating distances from non-selected data elements in the first data group to the representative data element; and selecting the representative data element as the particular data element from the first data group for modeling calculation in the case where the calculated distances from the non-selected data elements to the representative data element are all less than a preset threshold.

Optionally, selecting the particular data element from each of the data groups may include, for a first data group among the data groups: calculating distances from one or more non-selected data elements in the first data group to the representative data element; and correcting data elements in the first data group and selecting one data element from the corrected data elements as the particular data element for the modeling calculation in the case where a calculated distance from at least one of the non-selected data elements to the representative data element is greater than a preset threshold.

In a second aspect of the present disclosure, a data processing method is provided, which includes: performing a fingerprint calculation on each data element of a set of data elements to obtain fingerprint information of the data elements; grouping the data elements into data groups in accordance with the fingerprint information by grouping data elements with the same fingerprint information into a same data group; selecting a representative data element from each of the data groups; and for each of the data groups: calculating distances from other data elements in a data group to the representative data element of the data group; and determining incorrect data in the data group in accordance with the distances from the other data elements to the representative data element. The method may further include correcting the incorrect data.

Optionally, determining the incorrect data in the data group in accordance with the distances from the other data elements to the representative data element may include: determining, as the incorrect data, those of the other data elements with a distance to the representative data element that is greater than a preset threshold.

In a third aspect of the present disclosure, a data processing device is provided, which includes: a calculating unit, configured to perform a fingerprint calculation for each data element of a set of data elements to obtain fingerprint information of the data elements; a grouping unit, configured to group the data elements in accordance with the fingerprint information calculated by the calculating unit by grouping data elements with the same fingerprint information into a same data group; and a selecting unit, configured to select a particular data element from each of the data groups grouped by the grouping unit for modeling calculation in accordance with a preset strategy.

Optionally, the selecting unit may include: a first calculating subunit, configured to calculate distances from non-selected data elements in the first data group to the representative data element, and wherein the selecting unit is further configured to select the representative data element as the particular data element for the modeling calculation in the case where the distances from the non-selected data elements to the representative data element are all less than a preset threshold.

Optionally, the selecting unit may include: a first calculating subunit, configured to calculate distances from other data elements in the first data group except for the representative data selected by the second selecting subunit to the representative data; and a correcting subunit, configured to correct data elements in the first data group in the case where a calculated distance from one of the non-selected data elements to the representative data elements is greater than a preset threshold, wherein the selecting unit is further configured to select one data element from the data elements corrected by the correcting subunit as the particular data element from the first data element for the modeling calculation.

In a fourth aspect of the present disclosure, a data processing device is provided, which includes: a calculating unit, configured to perform a fingerprint calculation for each data element in a set of data elements to obtain fingerprint information of the data elements; a grouping unit, configured to group the data elements into data groups in accordance with the fingerprint information calculated by the calculating unit by grouping data elements with the same fingerprint information into a same data group; a selecting unit, configured to select a representative data element from each of the data groups grouped by the grouping unit; and a determining unit; and wherein for each of the data groups: the calculating unit is further configured to calculate distances from other data elements in a data group to the representative data element of the data group, and the determining unit is configured to determine incorrect data in the data group in accordance with the distances from the other data elements to the representative data element of the data group.

Optionally, the determining unit may be configured to determine the incorrect data in the data group by determining, as the incorrect data, those of the other data elements with a distance to the representative data element that is greater than a preset threshold.

Optionally, the device may further include a correcting unit, configured to correct the incorrect data.

In embodiments of the present disclosure, a fingerprint calculation is performed upon data elements be processed to obtain fingerprint information of the data elements. Data elements with the same (e.g., identical) fingerprint information is grouped into a same data group in accordance with the fingerprint information, and one data element is selected from each data group for a modeling calculation. Compared with other empirical models using a greater number of data elements or amount of data, the provided methods and devices of the present disclosure can reduce a data processing amount for modeling calculations, thereby reducing the time for data processing and improving the efficiency for data processing.

### BRIEF DESCRIPTION OF THE DRAWINGS

In order to illustrate the technical solutions according to the embodiments of the present disclosure more clearly, drawings to be used in the description of the embodiments will be described briefly hereinafter. The drawings described hereinafter are only some embodiments of the present disclosure, and other drawings may be obtained by those skilled in the art according to those drawings without creative labor.

FIG. 1 is a schematic diagram of an example of a data processing method according to an embodiment of the present disclosure;

FIG. 2 is a schematic diagram of another example of a data processing method according to an embodiment of the present disclosure;

FIG. 3 is a schematic diagram of yet another example of a data processing method according to an embodiment of the present disclosure;

FIG. 4 is a schematic diagram of an example of a data processing device according to an embodiment of the present disclosure;

FIG. 5 is a schematic diagram of another example of a data processing device according to an embodiment of the present disclosure;

FIG. 6 is a schematic diagram of yet another example of a data processing device according to an embodiment of the present disclosure;

FIG. 7 is a schematic diagram of still another example of a data processing device according to an embodiment of the present disclosure;

FIG. 8 is a schematic diagram of still yet another example of a data processing device according to an embodiment of the present disclosure;

FIG. 9 is a schematic diagram of a further example of a data processing device according to an embodiment of the present disclosure; and

FIG. 10 is a schematic diagram of a still further example of a data processing device according to an embodiment of the present disclosure.

### DETAILED DESCRIPTION

It is provided a data processing method according to an embodiment of the present disclosure, which can reduce data processing load for modeling calculation, and thereby can reduce the time for data processing and improve the efficiency for data processing. A corresponding device is also disclosed in an embodiment of the present disclosure. Hereinafter, the data processing method and data processing device are described in detail respectively.

The technical solutions in the embodiments of the present disclosure will be described clearly and completely hereinafter in conjunction with the drawings in the embodiments of the present disclosure. The described embodiments are only a part but not all of the embodiments of the present disclosure. All the other embodiments which can be obtained by those skilled in the art without creative effort on the basis of the embodiments of the present disclosure fall within the scope of protection of the present disclosure.

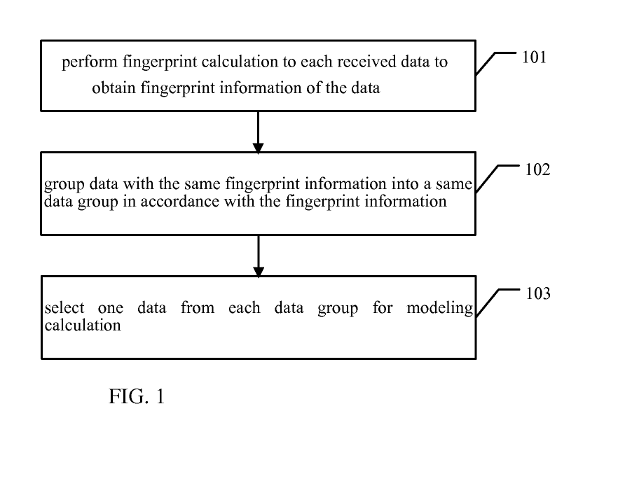

Referring to FIG. 1, an example of a data processing method according to an embodiment of the present disclosure includes the following steps 101 to 103.

101: performing fingerprint calculation on a set of data elements to obtain fingerprint information of the data elements.

The fingerprint information may refer to any information for indicating data features. Fingerprint calculating methods may include Message Digest Algorithm MD5 (MD5), local sensitive hash (LSH), and so on.

102: grouping one or more data elements with the same fingerprint information into a same data group in accordance with the fingerprint information.

As one illustrative example, fingerprint calculations may be performed on six data elements, which may be identified as data1, data2, data3, data4, data5 and data6. In this illustration, data1, data2, data5, and data6 have the same (e.g., identical or matching) fingerprint information, so the four data, i.e., data1, data2, data5, and data6, are grouped into the same data group, such as a first data group. Additionally in this illustration, data3 and data4 have the same fingerprint information, so the two data, i.e., data3 and data4, are grouped into the same data group, such as a second data group different from the first data group.

103: selecting one data element from each data group for modeling calculation.

The modeling calculation is known in the prior art, and is not described in detail in the present disclosure. In practice, the process of modeling is used to establish empirical models using data. Example empirical models include a support vector machine, a logistic regression, a neural network model, and so on.

A particular data element in a data group can be arbitrarily (e.g., randomly) selected from each data group for the modeling calculation in some embodiments of the present disclosure.

In the embodiment of the present disclosure, fingerprint calculation is performed on each data to obtain fingerprint information of the data; data with the same fingerprint information is grouped into a same data group in accordance with the fingerprint information; and one data is selected from each data group for modeling calculation. Compared with establishing empirical models using a greater number or amount of data, the method according to an embodiment of the present disclosure can reduce data processing amount for modeling calculations, and thereby reduce the time for data processing and improve the efficiency for data processing.

Optionally, on the basis of the above embodiment described with reference to FIG. 1, in another embodiment of a data processing method according to an embodiment of the present disclosure, selecting a data element from each data group for modeling calculation may include:

selecting one representative data element from each data group in accordance with a preset strategy;

calculating distances from the other data elements in a present data group (except for the representative data element) to the representative data element of the present data group; and

selecting the representative data element for the modeling calculation in the case where the calculated distances from the other data elements to the representative data element are all less than a preset threshold. The other data elements may be the non-selected data elements of the present data group, e.g., the data elements in the present data group besides the representative data element. The other data elements may also be referred to as non-representative data elements of the present data group.

In the embodiment of the present disclosure, the preset strategy may be a random selection strategy, an intermediate data selection strategy, or other strategies, and is not limited thereto.

There can be many distance calculation formulas for calculating the distance between data elements, including but not limited to the Euclidean distance calculation formula, the Hamming distance calculation formula, and the Mahalanobis distance calculation formula. For example, the Euclidean distance may be determined through the following illustrative calculations:

If a non-selected data element in the data group is data₁={0.5,0.3,0,0.2}, and the representative data element of the data group is is data₂={0.5,0,0.2,0,0.7},

then the Euclidean distance may be calculated as:

dist(data₁,data₂)=\sqrt{(1−0.5)²+(0.3−0)²+(0−0.2)²+(2−0.7)²}=1.43

The Euclidean distances from non-selected or non-representative data elements in the data group (e.g., data₃, data₄, data₅, and data₆) to the representative data element (data₂ in this illustration) are respectively 1.21, 1.35, 1.47 and 1.24. If a preset threshold has a value of 1.50, it may be determined that the distances from the other data elements in the data group to the representative data element are all less than the preset threshold, thereby the representative data element, i.e., data₂, can be selected directly for modeling calculation.

Optionally, on the basis of the above example described with reference to FIG. 1, in another example of a data processing method according to an embodiment of the present disclosure, the selecting a particular data element from each data group for modeling calculation may include:

selecting a representative data element from each data group in accordance with a preset strategy; and for each of the data groups:

calculating distances from the other data elements in a present data group to the representative data element of the present data group; and

correcting data in the present data group and selecting one data element from the corrected data elements for the modeling calculation in the case where at least one of the calculated distances from the other data elements to the representative data element is greater than a preset threshold.

In the embodiment of the present disclosure, the preset strategy may be a random selection strategy, an intermediate data selection strategy, or other strategies, and is not limited thereto.

There can be many distance calculation formulas for calculating the distance, including but not limited to the Euclidean distance calculation formula, the Hamming distance calculation formula, and the Mahalanobis distance calculation formula. For example, the Euclidean distance is taken as an example:

if one non-selected data element in the data group is data₁={0.5,0.3,0,0.2}, and the representative data element is data₂={0.5,0,0.2,0,0.7},

and the Euclidean distance:

dist(data₁,data₂)=\sqrt{(1−0.5)²+(0.3−0)²+(0−0.2)²+(2−0.7)²}=1.43

If the distances from the other data elements in the data group (e.g., data₃, data₄, data₅, and data₆) to the representative data element (data₂ in this illustration) are respectively 1.21, 1.35, 1.47 and 1.24, and the preset threshold is 1.30, it is determined that at least one of the distances from the other data elements in the data group to the representative data element is greater than the preset threshold, particularly the distances 1.43, 1.35, and 1.47 for data₁, data₄, and data₅ respectively. So, data₁, data₄ and data₅ can be corrected and the data elements, i.e., data₁ or other corrected data elements can be selected directly from the corrected data for modeling calculation. Optionally, the un-corrected, such as data₂, data₃, and data₆ in this illustration, may also be selected for modeling calculation.

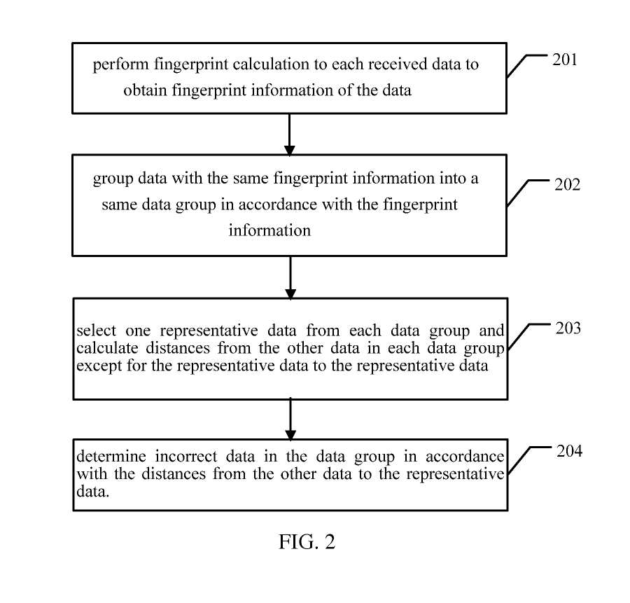

Referring to FIG. 2, another example of a data processing method according to an embodiment of the present disclosure includes the following steps 201 to 204.

201: performing fingerprint calculation on each data element in a set of a data elements to obtain fingerprint information of the data elements.

The fingerprint information may refer to information for indicating data features. Some exemplary fingerprint calculating methods are Message Digest Algorithm MD5 (MD5), local sensitive hash (LSH), and so on.

202: grouping data elements into data groups by grouping data elements with the same fingerprint information into a same data group in accordance with the fingerprint information.

For example, a set of data elements may include six data elements identified as data₁, data₂, data₃, data₄, data₅ and data₆. In on illustration, data₁, data₂, data₅ and data₆ have the same fingerprint information, so the four data, i.e., data₁, data₂, data₅ and data₆ are grouped into the same data group, such as a first data group. Additionally, data₃ and data₄ have the same fingerprint information, so the two data, i.e., data₃ and data₄ are grouped into the same data group, such as a second data group.

203: selecting one representative data element from each data group and calculating distances from the other data elements in each data group to the representative data element of the data group.

There can be many distance calculation formulas, including but not limited to the Euclidean distance calculation formula, the Hamming distance calculation formula, and the Mahalanobis distance calculation formula. One illustration of the Euclidean distance is presented as follows:

if one data element in the data group is data₁={0.5, 0.3,0,0.2}, and the representative data element of the data group is data₂={0.5,0,0.2,0,0.7},

then the Euclidean distance may be calculated as:

dist(data₁,data₂)=\sqrt{(1−0.5)²+(0.3−0)²+(0−0.2)²+(2−0.7)²}=1.43

The distances from the other data elements to the representative data element can all be calculated referring to the above-described method.

204: determining incorrect data in the data group in accordance with the distances from the other data elements to the representative data element.

In some implementations, fingerprint calculation is performed to each data element to obtain fingerprint information of the data; data elements with the same fingerprint information are grouped into a same data group in accordance with the fingerprint information; one representative data element is selected from each data group and distances from the other data elements in each data group to the representative data element of the data group are calculated; and incorrect data in the data group are determined in accordance with the distances from the other data element to the representative data element. Compared with traversing all the data elements to be processed one by one to find the incorrect data, the method according to an embodiment of the present disclosure can determine the incorrect data by the way of comparing distances, which may result in improved efficiency and accuracy for data processing.

Optionally, on the basis of the above example described with reference to FIG. 2, in another example of a data processing method according to an embodiment of the present disclosure, determining the incorrect data in the data group in accordance with the distances from the other data elements to the representative data element may include:

Determining, as the incorrect data, those of the other data elements from which the distances to the representative data element is greater than a preset threshold, in the case where at least one of the calculated distances from the other data to the representative data is greater than the preset threshold.

In one illustration a data group includes data elements identified as data₁, data₂, data₃, data₄, data₅ and data₆ and data₂ is selected as the representative data element, the distances from data₁, data₃, data₄, data₅, and data₆ respectively to data₂ may be calculated using the above described Euclidean distance formula, which result in distances respectively of 1.43, 1.21, 1.35, 1.47, and 1.24. If the preset threshold is set to 1.30, it is determined that the distances from the other data element in the data group to the representative data element with a value of 1.43, 1.35 and 1.47 are greater than the preset threshold, and thereby it is determined that data₁, data₄, and data₅ are incorrect data.

Optionally, on the basis of the above example described with reference to FIG. 2, in another example of a data processing method according to an embodiment of the present disclosure, the method may include:

correcting the incorrect data.

In the embodiment of the present disclosure, the incorrect data can be corrected in the case where it is determined that they are incorrect data.

In order to facilitate understanding, the process of the data processing according to an embodiment of the present disclosure is explained by taking an application scenario as an example below.

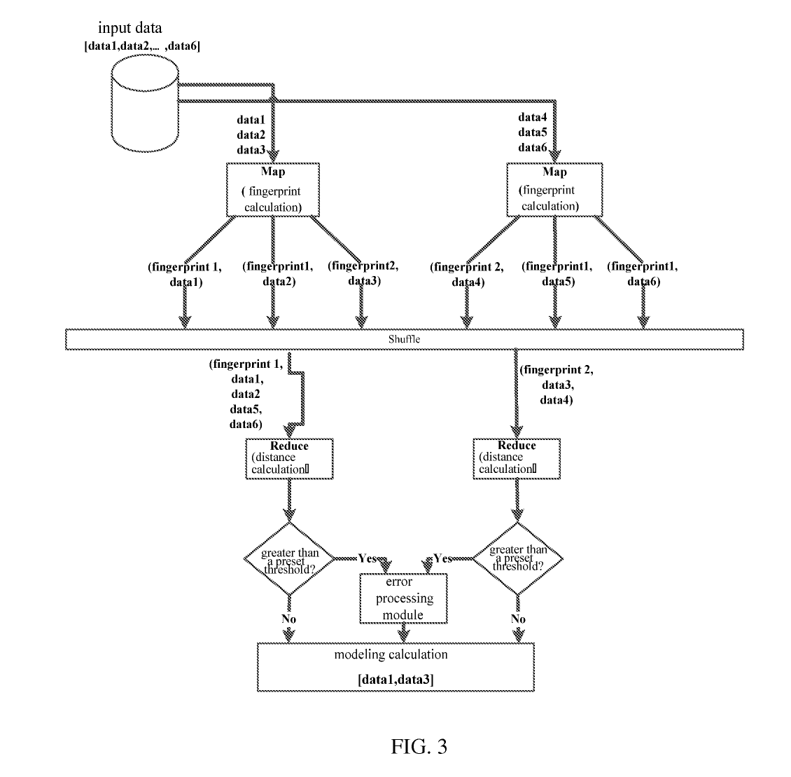

Referring to FIG. 3, six data elements, i.e., data₁, data₂, data₃, data₄, data₅ and data₆ are provided as input data, and the fingerprint calculation are respectively performed to the six data elements. Regarding the resulting fingerprint information values, the fingerprint information (e.g., value) of data₁ may be fingerprint) (e.g., a first fingerprint information value), the fingerprint information of the data₂ is also fingerprint1, the fingerprint information of the data₃ is fingerprint2 (e.g., a second fingerprint information value different from the first fingerprint information value), the fingerprint information of the data₄ is also fingerprint2, the fingerprint information of the data₅ is fingerprint1, and the fingerprint information of the data₆ is fingerprint1. Data elements with the fingerprint information of fingerprint1 are grouped into a same data group, and the data elements with the fingerprint information of fingerprint2 are grouped into a same data group. In this way, the data group with the fingerprint information of fingerprint1 includes data₁, data₂, data₅ and data₆, and the data group with the fingerprint information of fingerprint2 includes data₃ and data₄. One particular or representative data element can be selected directly from each of the two data groups for modeling calculation, and the distance calculation can also be performed to data elements in the two data groups. For example, the data₂ in the data group with the fingerprint information of fingerprint1 may be selected as the representative data element and the distances from non-selected data elements data₁, data₅ and data₆ to representative data element data₂ are calculated respectively.

For example, the distances calculated using the Euclidean distance formula are respectively 1.43, 1.37 and 1.46, and if the preset threshold is 1.5, the representative data element, i.e., data₂, can be selected for modeling calculation. If the preset threshold is 1.4, the distances of 1.43 and 1.46 are greater than the preset threshold 1.4, and thus data₁ and data₆ can be corrected and one or more data elements can be selected from the corrected data for the modeling calculation. Data₁ or data₂ which may not need correction, but can also be selected for modeling calculation.

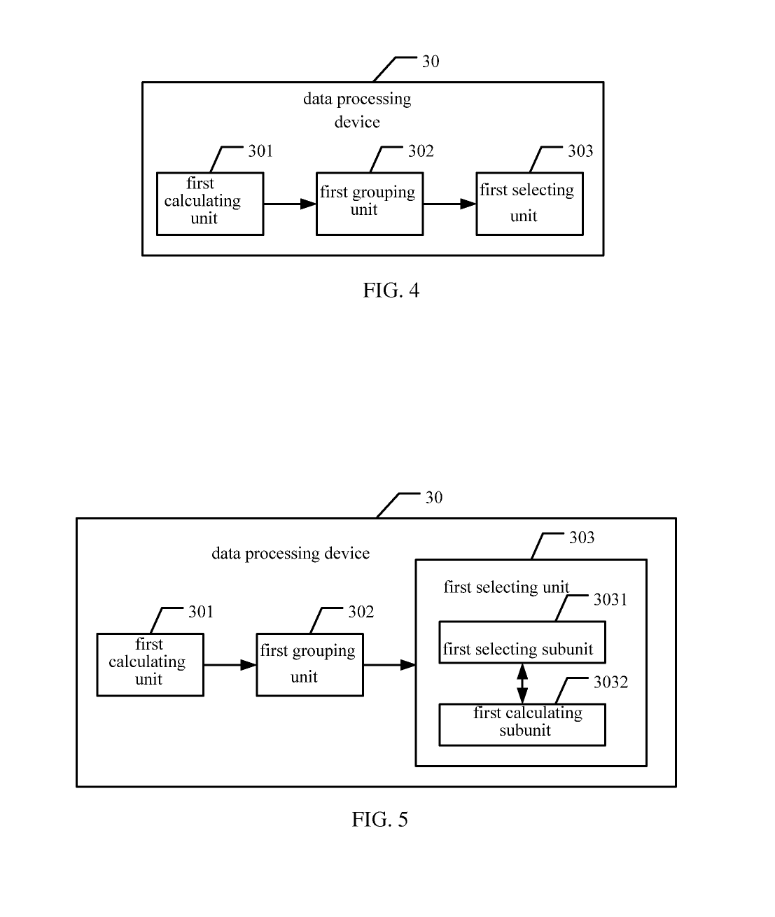

Referring to FIG. 4, an example of a data processing device according to an embodiment of the present disclosure includes:

a first calculating unit 301, configured to perform fingerprint calculation on each data to obtain fingerprint information of the data;

a first grouping unit 302, configured to group data elements with the same fingerprint information into a same data group in accordance with the fingerprint information calculated by the first calculating unit 301; and

a first selecting unit 303, configured to select one data element from each data group grouped by the first grouping unit 302 for modeling calculation.

In the embodiment of the present disclosure, the first calculating unit 301 may be configured to perform fingerprint calculation on each data element to obtain fingerprint information of the data elements; the first grouping unit 302 may be configured to group data elements with the same fingerprint information into a same data group in accordance with the fingerprint information calculated by the first calculating unit 301; and the first selecting unit 303 may be configured to select a particular data element from each data group grouped by the first grouping unit 302 for modeling calculation. Compared with other empirical models using a great number of data, the device according to an embodiment of the present disclosure can reduce the data processing amount for modeling calculation, which may result in reduced time for data processing and improved efficiency for data processing.

On the basis of the above example described with reference to FIG. 4, referring to FIG. 5, in another example of a data processing device according to an embodiment of the present disclosure, the first selecting unit 303 may include:

a first selecting subunit 3031, configured to select a representative data element from each data group in accordance with a preset strategy; and

a first calculating subunit 3032, configured to, for example for a present data group, calculate distances from the other data in the present data group to the representative data element selected for the present data group,

wherein the first selecting subunit 3031 is further configured to select the representative data element for a particular data group for the modeling calculation in the case where the distances from the other data elements in the particular data group to the representative data element of the particular data group are all less than a preset threshold.

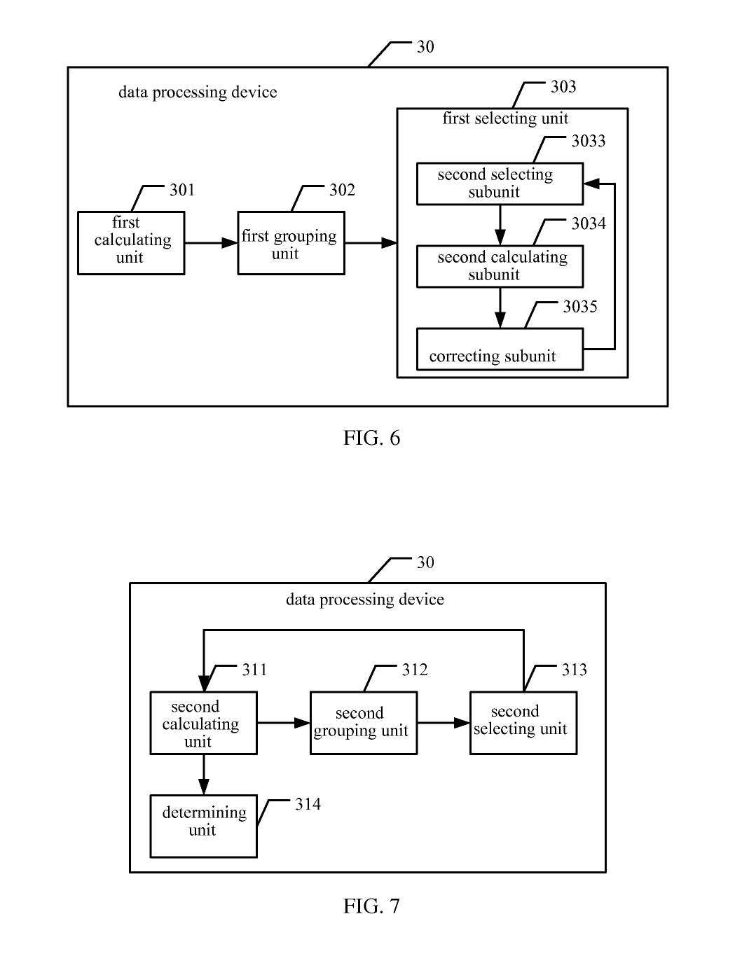

On the basis of the above example described with reference to FIG. 4, referring to FIG. 6, in another example of a data processing device according to an embodiment of the present disclosure, the first selecting unit 303 may include:

a second selecting subunit 3033, configured to select a representative data element from each data group in accordance with a preset strategy;

a second calculating subunit 3034, configured to calculate distances from the other data elements in a present data group to the representative data element of the present data group; and

a correcting subunit 3035, configured to correct data in the present data group in the case where at least one of the distances from the other data elements to the representative data elements calculated by the second calculating subunit 3034 is greater than a preset threshold,

wherein the second selecting subunit 3033 is further configured to select one or more data elements from the data elements corrected by the correcting subunit 3035 for modeling calculation.

Referring to FIG. 7, another example of a data processing device according to an embodiment of the present disclosure includes:

a second calculating unit 311, configured to perform fingerprint calculation to each data element of a set of data elements to obtain fingerprint information of the data elements;

a second grouping unit 312, configured to group data elements with the same fingerprint information into a same data group in accordance with the fingerprint information calculated by the second calculating unit;

a second selecting unit 313, configured to select a representative data element from each data group grouped by the second grouping unit 312;

wherein the second calculating unit 311 is further configured to calculate distances from the other data elements in each respective data group to the respective representative data element, and

a determining unit 314, configured to determine incorrect data in the data group in accordance with the distances from the other data elements of the data group to the representative data element of the data group, as calculated by the second calculating unit 311.

On the basis of the above example described with reference to FIG. 7, in another example of a data processing device according to an embodiment of the present disclosure, the determining unit 314 is configured to determine those of the other data elements with a distance to the representative data element that is than a preset threshold as the incorrect data, and in the case where at least one of the calculated distances from the other data element to the representative data element is greater than the preset threshold.

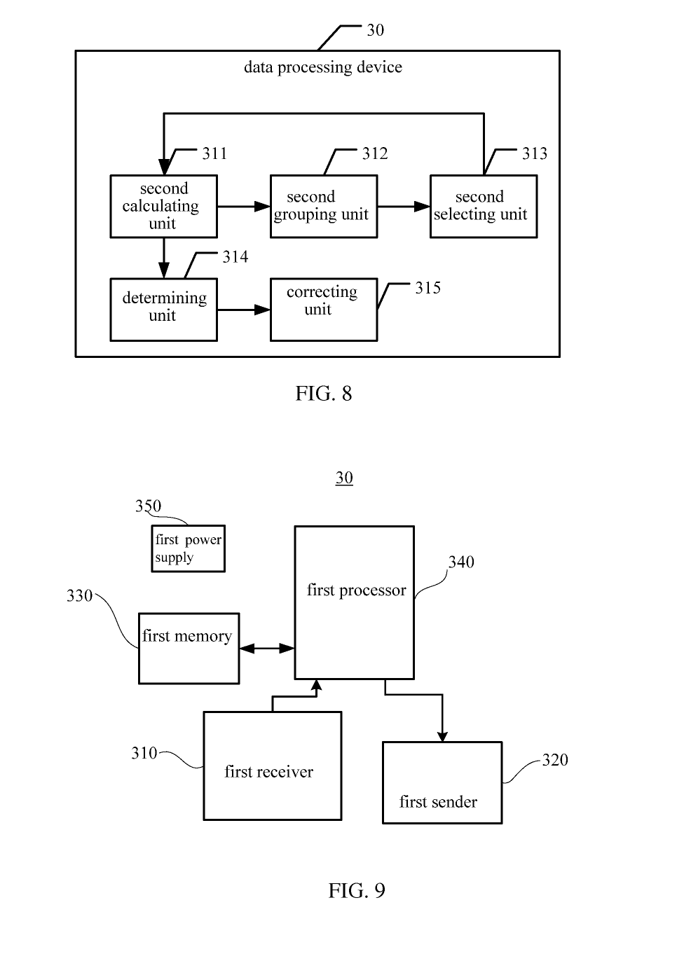

On the basis of the above example described with reference to FIG. 7, referring to FIG. 8, another example of a data processing device according to an embodiment of the present disclosure may further include:

a correcting unit 315, configured to correct the incorrect data, e.g., incorrect data elements.

Referring to FIG. 9, which is a structural schematic diagram of a data processing device according to an embodiment of the present disclosure, the data processing device can be configured to implement a data processing method according to an embodiment of the present disclosure.

Referring to FIG. 9, the data processing device 30 includes a first receiver 310, a first sender 320 (which may also be referred to as transmitter), a first memory 330 and a first processor 340. Specifically, the first receiver 310, the first sender 320, the first memory 330 and the first processor 340 are connected via a bus or in other ways.

The first memory 330 includes one or more computer-readable storage medium. The number of the first processor 340 can be at least one. The data processing device 30 may further include components such as a first power supply 350. It can be understood by those skilled in the art that the data processing device is not limited to the one shown in FIG. 9, and can include more or less components than those as shown or the combination of some components or different arrangement of the components.

The first memory 330 may be configured to store software programs and modules, and the first processor 340 performs various function applications and data processing by operating the software programs and modules stored in the first memory 330. The first memory 330 may include a program storage area and a data storage area. Specifically, the program storage area may store an operating system, and application programs needed by at least one function. Further, the first memory 330 may include a high speed random access first memory, or can include a nonvolatile first memory such as at least one disk first storage device, Flash storage device or other volatile solid first storage device. Accordingly, the first memory 330 may further include a first memory controller to provide the first processor 340 and the first receiver 310 with the access to the first memory 330.

The first processor 340 is the control center of the data processing device 30. It connects various parts of the data processing device 30 by using a variety of interfaces and lines, and performs various functions of proxy server and processes data by operating software programs and/or modules stored in the first memory 330 and by calling the data stored in the first memory 330. Optionally, the first processor 340 may include one or more processing cores. Preferably, the first processor 340 can be integrated with application first processor first modulation/demodulation first processor.

The data processing device 30 further include the first power supply 350 (such as a battery) for supplying power to various components. Preferably, the power supply can be logically connected to the first processor 340 via a power supply management system, thereby it can realize the charging, discharging, and power management and other functions through the power supply management system. The first power supply 350 may also include one or more DC or AC power supplies, a recharging system, a power failure detection circuit, a power supply converter or inverter, a power status indicator and other arbitrary components.

The data processing device 30 may perform any of the techniques or methods described above and may implement any of the device functionality and device units described above. For example, the first processor 340 may be configured to: perform a fingerprint calculation on each data element in a set of data elements to obtain fingerprint information of the data elements; group the data elements into data groups in accordance with the fingerprint information by grouping data elements with the same fingerprint information into a same data group; and select a particular data element from each of the data groups for modeling calculation.

In some embodiments of the present disclosure, the first processor 340 may be further configured to: select a representative data element from each data group in accordance with a preset strategy; calculate distances from other data elements of a data group to the representative data element of the data group; and select the representative data element for the data group for modeling calculation in the case where the calculated distances from the other data elements to the representative data element are all less than a preset threshold.

In some embodiments of the present disclosure, the first processor 340 may be further configured to: select a representative data element from each data group in accordance with a preset strategy; calculate distances from the other data elements in a present data group to the representative data element of the present data group; and correct data in the present data group and select one data element from the corrected data for modeling calculation in the case where at least one of the calculated distances from the other data elements to the representative data element is greater than a preset threshold.

In another aspect, a computer-readable storage medium is provided in a further embodiment of the present disclosure. The computer-readable storage medium may be included in the first memory in the above embodiment, or may be separated and not assembled into the terminal. In the computer-readable storage medium, one or more programs are stored. The one or more programs are executed by one or more first processors to perform a data processing method which includes:

performing a fingerprint calculation on each data element of a set of data elements to obtain fingerprint information of the data elements;

grouping the data elements into data groups in accordance with the fingerprint information by grouping data elements with the same fingerprint information into a same data group; and

selecting a particular data element from each of the data groups for modeling calculation.

Optionally, selecting the particular data element from each data group for modeling calculation may include:

selecting a representative data element from a present data group in accordance with a preset strategy;

calculating distances from the other data elements in the present data group to the representative data element of the present data group; and

selecting the representative data element of the present data group for modeling calculation in the case where the calculated distances from the other data elements to the representative data element are all less than a preset threshold.

Optionally, selecting the particular data element from each data group for modeling calculation may include:

selecting a representative data element from a present data group in accordance with a preset strategy;

calculating distances from other data elements in the present data group to the representative data element; and

correcting data in the present data group and selecting one data element from the corrected data for the present data group for the modeling calculation in the case where at least one of the calculated distances from the other data elements to the representative data element is greater than a preset threshold.

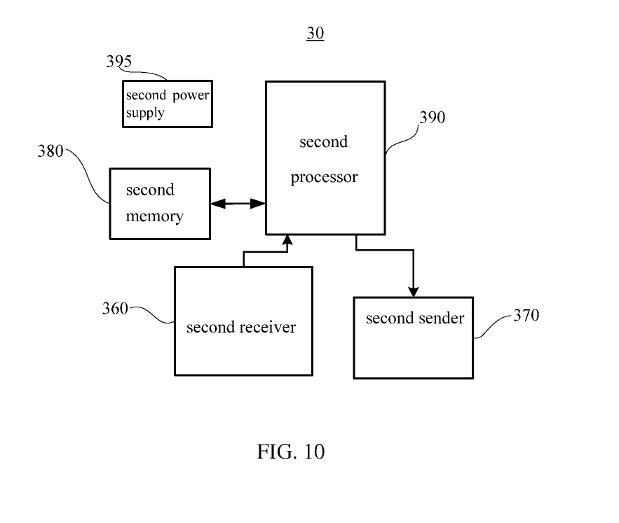

Referring to FIG. 10, which is a structural schematic diagram of a data processing device according to an embodiment of the present disclosure, the data processing device can be configured to implement a data processing method according to the above embodiments of the present disclosure.

Referring to FIG. 10, another example of the data processing device 30 includes a second receiver 360, a second sender 370 (or transmitter), a second memory 380 and a second processor 390. Specifically, the second receiver 360, the second sender 370, the second memory 380 and the second processor 390 are connected via a bus or in other ways.

The second memory 380 includes one or more computer-readable storage medium. The number of the second processor 390 can be at least one. The data processing device 30 may further include components such as a second power supply 395. It can be understood by those skilled in the art that the data processing device is not limited to the one shown in FIG. 10, and can include more or less components than those shown or the combination of some components or different arrangement of the components.

The second memory 380 may be configured to store software programs and modules, and the second processor 390 performs various function applications and data processing by operating the software programs and modules stored in the second memory 380. The second memory 380 may include a program storage area and a data storage area. Specifically, the program storage area may store an operating system, and application programs needed by at least one function. Further, the second memory 380 may include a high speed random access second memory, or can include a nonvolatile second memory such as at least one disk second storage device, Flash storage device or other volatile solid second storage device. Accordingly, the second memory 380 may further include a second memory controller to provide the second processor 390 and the second receiver 360 with the access to the second memory 380.

The second processor 390 is the control center of the data processing device 30. It is connected with various parts of the data processing device 30 by using a variety of interfaces and lines, and performs various functions of proxy server and processes data by operating or executing software programs and/or modules stored in the second memory 380 and by calling the data stored in the second memory 380. Optionally, the second processor 390 may include one or more processing cores. Preferably, the second processor 390 can be integrated with application first processor first modulation/demodulation first processor.

The data processing device 30 may further include the second power supply 395 (such as a battery) for supplying power to various components. Preferably, the power supply can be logically connected to the second processor 390 via a power supply management system, thereby it can realize the charging, discharging, and power management and other functions through the power supply management system. The second power supply 395 may also include one or more DC or AC power supplies, a recharging system, a power failure detection circuit, a power supply converter or inverter, a power status indicator and other arbitrary components.

The data device 30 may perform any of the methods discussed herein or implement any of the device functionality discussed herein. For example, the second processor 390 may be configured to: perform a fingerprint calculation on each data element in a set of data elements to obtain fingerprint information of the data elements; group the data elements into data groups in accordance with the fingerprint information by group data elements with the same fingerprint information into a same data group; select one representative data element from each data group and calculating distances from the other data elements in each data group to the representative data of the particular data group; and determine incorrect data in the data group in accordance with the distances from the other data elements to the representative data element.

In some embodiments of the present disclosure, the second processor 390 may be further configured to determine, as the incorrect data, those of the other data elements with a distance to the representative data element that is greater than a preset threshold, and in the case where at least one of the calculated distances from the other data elements to the representative data element is greater than the preset threshold.

In some embodiments of the present disclosure, the second processor 390 may be further configured to correct the incorrect data.

In another aspect, a computer-readable storage medium is provided in a further embodiment of the present disclosure. The computer-readable storage medium may be included in the second memory in the above embodiment, or may be separated and not assembled into the terminal. In the computer-readable storage medium, one or more programs are stored. The one or more programs are executed by one or more second processors to perform a data processing method which includes:

performing fingerprint calculation on each data element in a set of data elements to obtain fingerprint information of the data elements;

grouping the data elements into data groups in accordance with the fingerprint information by grouping data elements with the same fingerprint information into a same data group;

selecting one representative data element from each data group and calculating distances from the other data elements in a present data group to the representative data element of the present data group; and

determining incorrect data in the present data group in accordance with the distances from the other data elements to the representative data element.

Optionally, determining the incorrect data in the data group in accordance with the distances from the other data elements to the representative data element may include:

Determining, as the incorrect data, those of the other data elements with a distance to the representative data element that is greater than a preset threshold, and in the case where at least one of the calculated distances from the other data elements to the representative data element is greater than the preset threshold.

In a third embodiment provided on the basis of the first or second embodiment, the method performed by the one or more programs may further include:

correcting the incorrect data.

It can be understood by those skilled in the art that all or a part of the steps of various methods in the above embodiments can be realized by using programs to instruct relevant hardware. The program may be stored in a computer-readable storage medium, and the storage medium may include ROM, RAM, disk, or optical disk.

The data processing method and device according to the embodiment of the present disclosure have been described in detail above. Specific examples are applied to set out the principles of the disclosure and the embodiments herein, and the description of the above embodiments is only intended to assist to understand the method of the disclosure and its core ideas. Meanwhile, it can be understood by those skilled in the art that variations can be made to the specific embodiment and application scope depending on the idea of the present disclosure. From the above, the specification should not be understood to limit the present disclosure.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A data processing method, comprising:
through a processor:
performing a fingerprint calculation for each data element of a set of data elements to obtain fingerprint information of the data elements;
grouping the data elements into data groups in accordance with the fingerprint information, by grouping data elements with identical fingerprint information into a same data group; and
selecting a particular data element from each of the data groups for modeling calculation in accordance with a preset strategy.

2. The method according to claim 1, wherein selecting the particular data element from each of the data groups comprises, for a first data group among the data groups:
calculating distances from one or more non-selected data elements in the first data group to the representative data element; and
selecting the representative data element as the particular data element from the first data group for the modeling calculation in the case where the calculated distances from the non-selected data elements to the representative data element are all less than a preset threshold.

3. The method according to claim 1, wherein selecting the particular data element from each of the data groups comprises, for a first data group among the data groups:
calculating distances from one or more non-selected data elements in the first data group to the representative data element; and
correcting data elements in the first data group and selecting one data element from the corrected data elements as the particular data element from the first data group for the modeling calculation in the case where a calculated distance from one of the non-selected data elements to the representative data element is greater than a preset threshold.

4. A data processing method, comprising:
performing a fingerprint calculation for each data element of a set of data elements to obtain fingerprint information of the data elements;
grouping the data elements into data groups in accordance with the fingerprint information by grouping data elements with identical fingerprint information into a same data group;
selecting a representative data element from each of the data groups; and
for each of the data groups:
calculating distances from other data elements in a data group to the representative data element of the data group; and
determining incorrect data in the data group in accordance with the distances from the other data elements to the representative data element.

5. The method according to claim 4, further comprising correcting the incorrect data.

6. The method according to claim 4, wherein determining the incorrect data in the data group in accordance with the distances from the other data elements to the representative data element comprises:
determining, as the incorrect data, those of the other data elements with a distance to the representative data element that is greater than a preset threshold.

7. The method according to claim 6, further comprising correcting the incorrect data.

8. A data processing device, comprising:
a calculating unit configured to perform a fingerprint calculation for each data element of a set of data elements to obtain fingerprint information of the data elements;
a grouping unit configured to group the data elements into data groups in accordance with the fingerprint information calculated by the calculating unit by grouping data elements with identical fingerprint information into a same data group; and
a selecting unit configured to select a particular data element from each of the data groups for modeling calculation in accordance with a preset strategy.

9. The device according to claim 8, wherein the selecting unit comprises:
a first calculating subunit configured to calculate distances from non-selected data elements in the first data group to the representative data element selected by the selecting subunit; and
wherein the selecting unit is further configured to select the representative data element as the particular data element from the first data group for the modeling calculation in the case where the calculated distances from the non-selected data elements to the representative data element are all less than a preset threshold.

10. The device according to 8, wherein the selecting unit comprises:
a first calculating subunit configured to calculate distances from one or more non-selected data elements in the first data group to the representative data element; and
a correcting subunit configured to correct data elements in the first data group in the case where a calculated distance from one of the non-selected data elements to the representative data element is greater than a preset threshold, and
wherein the selecting unit is further configured to select one data element from the data elements corrected by the correcting subunit as the particular data element from the first data group for the modeling calculation.

11. A data processing device, comprising:
a calculating unit configured to perform a fingerprint calculation for each data element of a set of data elements to obtain fingerprint information of the data elements;
a grouping unit configured to group the data elements into data groups in accordance with the fingerprint information calculated by the calculating unit, by grouping data elements with identical fingerprint information into a same data group;
a selecting unit configured to select a representative data element from each of the data groups grouped by the grouping unit; and
a determining unit; and
wherein for each of the data groups:
the calculating unit is further configured to calculate distances from other data elements in a data group to the representative data element of the data group; and
the determining unit is configured to determine incorrect data in the data group in accordance with the distances from the other data elements to the representative data element of the data group.

12. The device according to claim 11, further comprising a correcting unit configured to correct the incorrect data.

13. The device according to claim 11, wherein the determining unit is configured to determine the incorrect data in the data group by determining, as the incorrect data, those of the other data elements with a distance to the representative data element that is greater than a preset threshold.

14. The device according to claim 13, further comprising a correcting unit configured to correct the incorrect data.
